(19) United States
(12) Patent Application Publication
(10) Pub. No.: US 2009/0035522 A1
(43) Pub. Date: Feb. 5, 2009

(54) Forming electrically isolated conductive traces

(76) Inventors: Gilbert G. Smith, Corvallis, OR (US); Kevin D. Almen, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/831,640

(22) Filed: Jul. 31, 2007

(51) Int. Cl. B32B 3/00; B05D 5/12

(52) U.S. Cl. 428/156; 427/58

(57) ABSTRACT

A pattern is imprinted into a substrate. The pattern has a number of raised regions and a number of trenches such that the raised regions are separated from one another by the trenches. The raised regions correspond to electrically isolated conductive traces to be formed on the substrate. At least an angle of deposition relative to the substrate at which an electrically conductive material is to be deposited on the substrate to form the electrically isolated conductive traces on the raised regions is determined. The angle of deposition is sufficient to ensure that adjacent raised regions remain electrically isolated. The electrically conductive material is deposited at no more than the angle of deposition relative to the substrate to form the electrically isolated conductive traces.

### BACKGROUND

Radio-frequency identification (RFID) is an automatic identification process, relying on storing and remotely retrieving data using devices called RFID tags or transponders. An RFID tag is an object that can be attached to or incorporated into a product, animal, or person for the purpose of identification using radio signals. Most RFID tags contain at least two parts. One is an integrated circuit for storing and processing information, modulating and demodulating an RF signal, as well as performing other functionality. The second is an antenna for receiving and transmitting the signal. The antenna is desirably small, but still has to be able to transmit and/or receive radio signals within a specified distance.

### BRIEF DESCRIPTION OF THE DRAWINGS

FIGS. 1A and 1B are top view diagrams of an example electrical device having electrically isolated conductive traces, according to varying embodiments of the present disclosure.

FIG. 2 is a partial perspective view diagram of an electrical device having electrically isolated conductive traces, according to an embodiment of the present disclosure.

FIG. 3 is a partial cross-sectional front view diagram of an electrical device having electrically isolated conductive traces, in which an angle of deposition is specifically depicted, according to an embodiment of the present disclosure.

FIGS. 4A and 4B are top view diagrams of simple patterns having different geometries, in which angles of rotation are specifically depicted, according to varying embodiments of the present disclosure.

FIG. 5 is a flowchart of a method for forming electrically isolated conductive traces by depositing an electrically conductive material on an electrically insulative substrate at an angle of deposition, according to an embodiment of the present disclosure.

FIGS. 6A and 6B are diagrams depicting how, for a straight-line geometry, an angle of deposition can determine whether conductive traces remain electrically isolated or not, according to varying embodiments of the present disclosure.

FIGS. 7A and 7B are diagrams depicting how, for a circular geometry, an angle of deposition can determine whether conductive traces remain electrically isolated or not, according to varying embodiments of the present disclosure.

FIG. 8 is a diagram illustratively depicting a number of values employed to determine an angle of deposition for a circular geometry, according to an embodiment of the present disclosure.

### DETAILED DESCRIPTION OF THE DRAWINGS

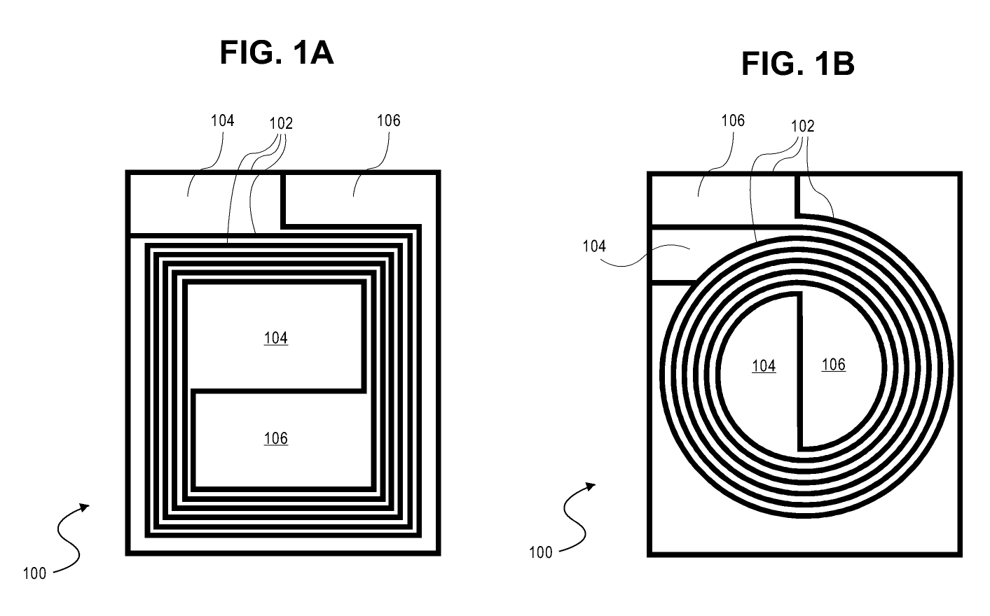

FIGS. 1A and 1B show top views of an example electrical device 100, according to different embodiments of the present disclosure. The electrical device 100 of FIG. 1A has a pattern with a straight-line geometry. The pattern of the electrical device 100 of FIG. 1A thus includes features made up of a number of straight lines oriented perpendicular to one another, making up squares or other types of rectangles. By comparison, the electrical device 100 of FIG. 1 B has a pattern with a circular geometry. The pattern of the electrical device 100 of FIG. 1B thus includes a number of concentric circular features. It is noted that more generally, the electrical device 100 can have a combination of circular and straight components.

The electrical device 100 may be a radio-frequency identification (RFID) tag antenna, or another type of electrical device. The electrical device 100 includes a number of trenches 102. The trenches 102 electrically isolate adjacent conductive traces 104 and 106 from one another. As such, the conductive traces 104 and 106 are electrically isolated conductive traces. As will be seen in more detail later in the detailed description, the conductive traces 104 and 106 are formed on raised regions separated from one another by the trenches 102.

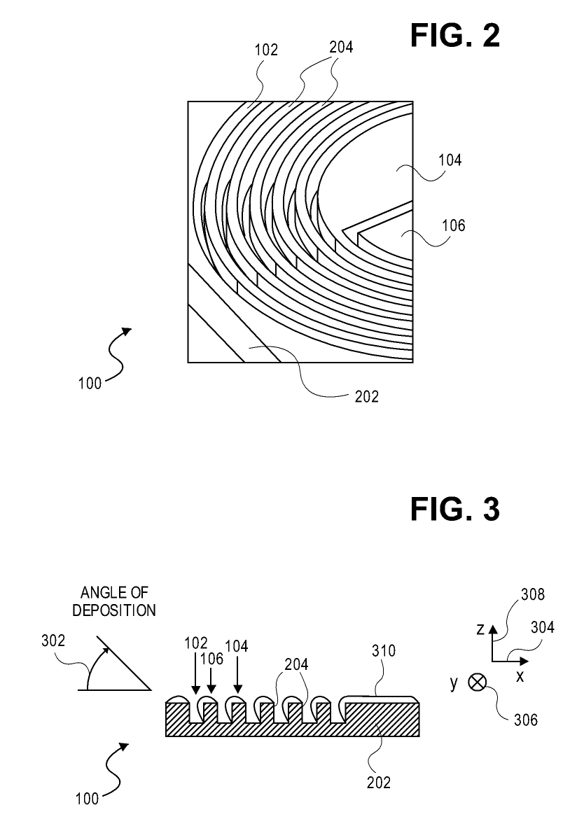

FIG. 2 shows a partial perspective view of the electrical device 100, according to an embodiment of the present disclosure. The electrical device 100 of FIG. 2 particularly has the circular geometry of FIG. 1B. The electrical device 100 includes a substrate 202. The pattern that is imprinted into the substrate 202 is present over three dimensions, including the concentric circular features over the plane of the substrate 202 (i.e., over the x-axis and the y-axis), and the trenches 102 formed within the substrate (i.e., within the z-axis).

The substrate 202 is electrically insulative. An electrically conductive material, such as aluminum, is deposited on primarily the raised regions 204 of the substrate 202 to form the conductive traces 104 and 106. Due to the geometry and the angle of deposition, as will be described in more detail, the electrically conductive material is not sufficiently deposited along the sidewalls and the floors of the trenches 102 to result in electrical conductivity between adjacent conductive traces 104 and 106. As such, the conductive trace 104 is electrically isolated from the conductive trace 106, and vice-versa.

FIG. 3 shows a partial cross-sectional front view of the electrical device 100, according to an embodiment of the present disclosure. Identified for illustrative clarity in FIG. 3 are x-axis 304 and the y-axis 306, which define the plane of the electrical device 100, as well as the z-axis 308. An angle of deposition 302 is depicted in FIG. 3 as well, which rises from a surface of the electrical device 100 at a position along the plane defined by the x-axis 304 and the y-axis 306, into the z-axis 308.

An electrically conductive material 310 is deposited on the substrate 202 of the electrical device 100 inwards from the angle of deposition 302 towards the substrate 202. As such, the conductive traces 104 and 106 are formed as the coated raised regions 204 that are separated from the trenches 102. The angle of deposition 302 has a maximum value such that deposition of the electrically conductive material 310 at this angle 302 does not result in adjacent conductive traces 104 and 106 being electrical conductive with one another. That is, the conductive traces 104 and 106 remain electrically isolated.

For instance, if the angle of deposition 302 were ninety degrees, then the electrically conductive material 310 deposited at this angle 302 would likely coat the sidewalls and the floors of the trenches 102, as well as the raised regions 204. As such, the conductive traces 104 and 106 would undesirably become electrically connected with one another, and would not be electrically isolated. Therefore, the angle of deposition 302 is sufficiently small that deposition of the electrically conductive material 310 at this angle 302 does not result in sufficient coating of the sidewalls and floors of the trenches 102 to electrically connect adjacent conductive traces 104 and 106.

It is noted that the angle of deposition 302 represents the angle at which the electrically conductive material 310 is deposited on the substrate 202 of the electrical device 100 relative to the surface of the substrate 202, rising towards the z-axis 308. There is another angle at which the electrically conductive material 310 is deposited on the substrate 202, however, which is the angle relative to one of the x- and y-axes 304 and 306 towards the other of the x- and y-axes 304 and 306, within the plane defined by the x-axis 304 and the y-axis 306. This additional angle is referred to as the angle of rotation, or the slew angle. The angle of deposition rises from the plane defined by the x- and y-axes 304 and 306 at the position defined by the angle of rotation.

For the circular geometry of the pattern of FIG. 1B, the angle of rotation at least substantially does not matter, because no matter where along the plane the angle of deposition 302 radially rises towards the z-axis 308, the angle of rotation intersects tangents of the circular features of this geometry at ninety degrees. However, for the straight-line geometry of the pattern of FIG. 1A, the angle of rotation can matter. This is because depending where along the plane the angle of deposition 302 radially rises into the z-axis 308, the angle of rotation intersects the straight-line features of this geometry at different angles. Desirably, the angle of rotation is such that it is maximized relative to the straight-line geometry.

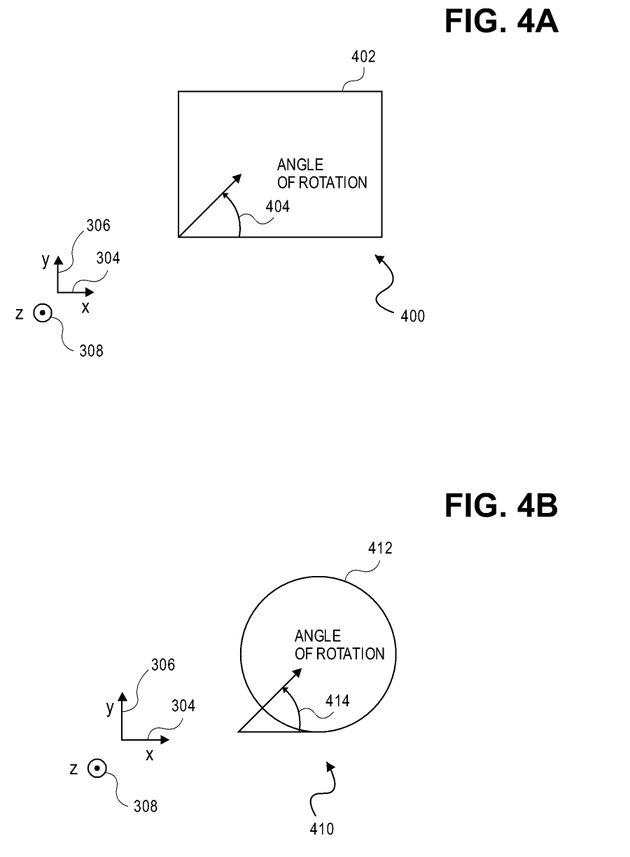

FIGS. 4A and 4B show example angles of rotations in relation to simple patterns having geometries corresponding to those of FIGS. 1A and 1B, respectively, according to different embodiments of the present disclosure. Depicted in FIGS. 4A and 4B are the x-axis 304, the y-axis 306, and the z-axis 308. As such, both FIGS. 4A and 4B are top views of their respective patterns, where the angle of deposition extends upwards from the plane of these figures into the z-axis 308.

In FIG. 4A, a pattern 400 includes a single straight-line feature 402 for illustrative convenience, specifically a rectangle. An angle of rotation 404 is defined from a base line that is parallel to the x-axis 304 specifically, and thus parallel to two of the lines of the rectangle and perpendicular to the other two lines of the rectangle. The angle of rotation 404 is maximized in relation to these lines. As such, the angle of rotation 404 is 45 degrees, since this is the value at which the angle of rotation 404 is maximized in relation to all four lines of the rectangle making up the pattern 400. The angle of deposition rises upwards towards the z-axis 308 from a position on the plane defined by the x-axis 304 and the y-axis 306, the position specified by the angle of rotation 404.

By comparison, in FIG. 4B, a pattern 410 includes a single circular feature 412 for illustrative convenience, specifically a circle. An angle of rotation 414 is defined from a base line that is parallel to the x-axis 304 specifically. However, the angle of rotation 414 does not actually matter in relation to the circle. This is because regardless of what the angle of rotation 414 is, it is always parallel to a ray extending radially from the center of the circle. As such, although it can be stated the angle of deposition rises upwards towards the x-axis 308 from a position on the plane defined by the x-axis 304 and the y-axis, where the position is specified by the angle of rotation 414, in actuality it does not matter what this angle of rotation 414 is where the pattern 410 has a circular geometry. By comparison, in at least some embodiments, what can matter for circular geometries is the radius of curvature relative to trench depth and deposition angle.

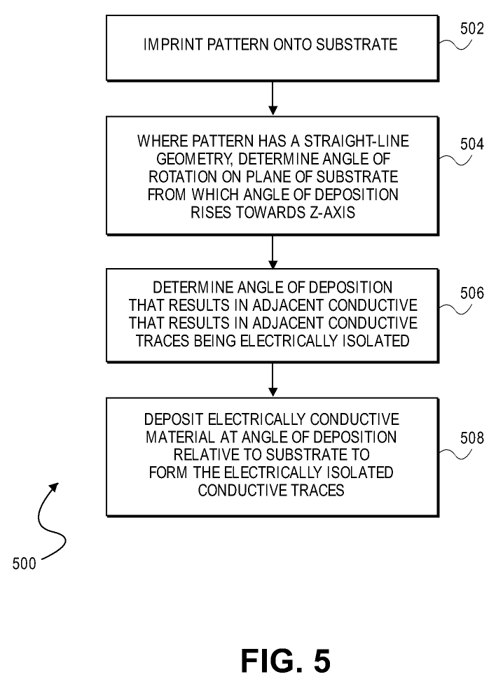

FIG. 5 shows a method 500, according to an embodiment of the present disclosure. The method 500 can be employed to at least partially fabricate the electrical device 100 that has been described. A desired pattern is imprinted into a substrate (502). For instance, the pattern may be embossed or nano-imprinted into the substrate. The substrate is electrically insulative. The pattern is imprinted into the substrate over three dimensions, including an x-axis and a y-axis over which a plane of the substrate is defined, as well as a z-axis extending into and out of the plane of the substrate. The pattern upon being imprinted into the substrate has raised regions and trenches. The raised regions are separated from one another by the trenches. The raised regions correspond to electrically isolated conductive traces to be formed on the substrate.

Where the pattern has a straight-line geometry, as opposed to, for instance, a circular geometry, an angle of rotation on the plane of the substrate from which an angle of deposition rises towards the z-axis is determined (504). The angle of rotation may be empirically determined. The angle of rotation is maximized relative to the straight-line rotation. Thus, the maximum angle of deposition rises into or towards the z-axis from a position on the plane of the substrate, the position being denoted by the angle of rotation. That is, the actual angle of deposition should not be greater than this maximum angle. As such, an electrically conductive material is to be deposited at the angle of deposition above the substrate from a direction corresponding to the angle of rotation relative to the straight-line geometry, to form the conductive traces. In one embodiment, the angle of rotation is relative to the straight-line geometry such that it is parallel to the x-axis and is angled towards the y-axis, where the straight-line geometry itself has one or more straight-line features that are parallel to the x-axis. In another embodiment, the angle of rotation is relative to the straight-line geometry such that it is parallel to the y-axis and is angled towards the x-axis, where the straight-line geometry itself has one or more straight-line features that are parallel to the y-axis.

An angle of deposition that results in adjacent conductive traces being electrically isolated is determined (506). The angle of deposition is relative to the surface or plane of the substrate, and is the angle at which an electrically conductive material is to be deposited on the substrate to form the conductive traces on the raised regions. The angle of deposition is sufficient to ensure that adjacent raised regions remain electrically isolated upon the electrically conductive material being deposited thereon. That is, the angle of deposition is such that during deposition the electrically conductive material is insufficiently deposited along sidewalls and floors of the trenches to result in electrical conductivity between adjacent raised regions. In other words, a continuous shadow results where no conductive material is deposited, such that the traces are electrically isolated.

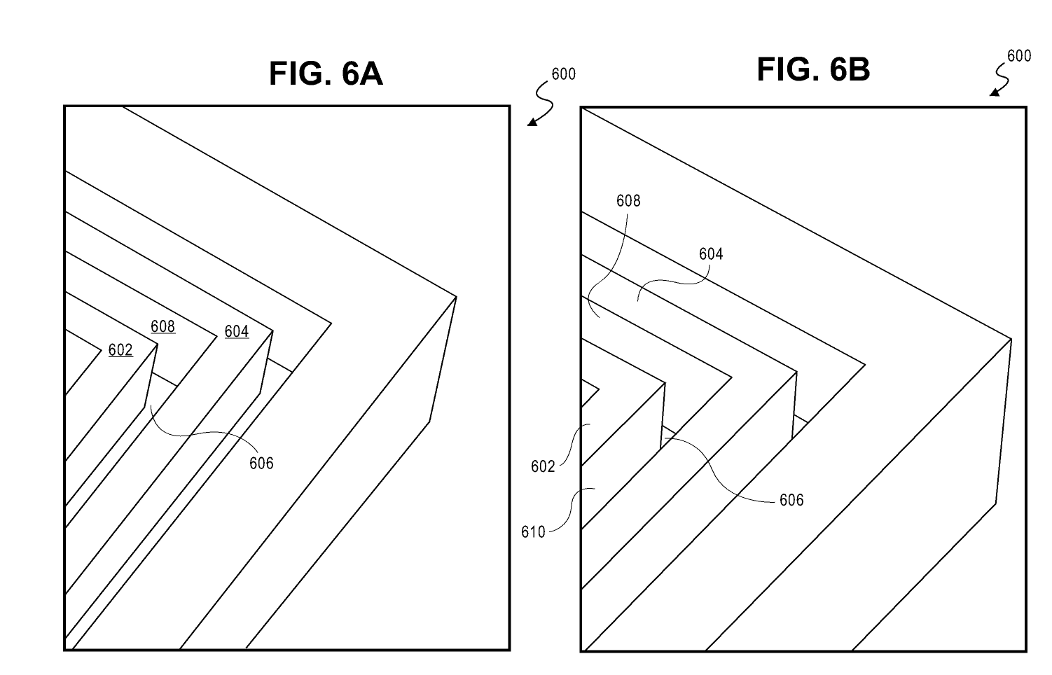

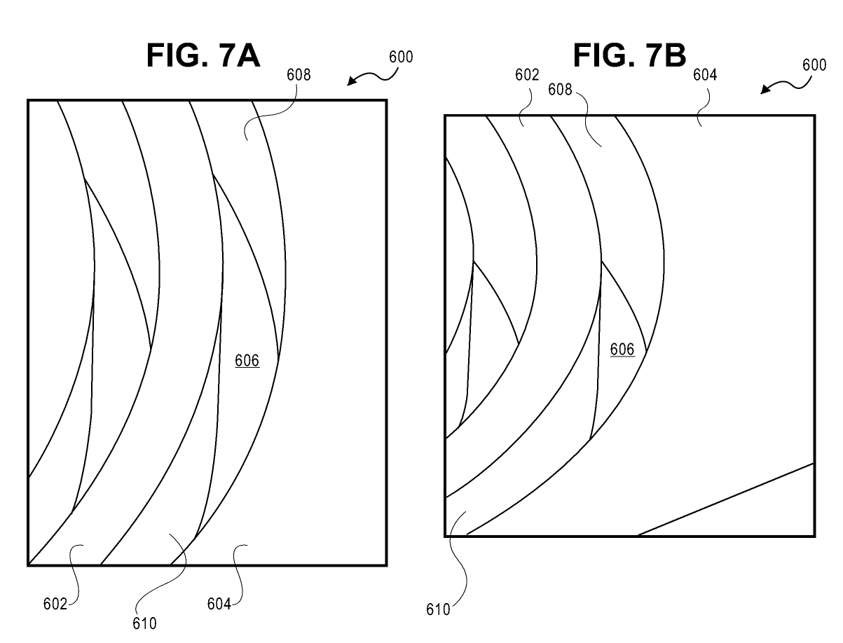

FIGS. 6A and 6B show how the angle of deposition can affect whether the traces are electrically isolated or not, for a straight-line geometry, according to an embodiment of the present disclosure, and FIGS. 7A and 7B show how the angle of deposition can affect whether the traces are electrically isolated or not, for a circular geometry, according to an embodiment of the present disclosure. In FIGS. 6A, 6B, 7A, and 7B, a portion of an electrical device 600 is depicted having raised regions 602 and 604, which are to correspond to two electrically isolated traces. Between the raised regions 602 and 604 is a trench that has a floor 606, and sidewalls 608 and 610.

If electrically conductive material is deposited at an angle of deposition equal to the perspective view depicted in FIGS. 6A and 7A, the traces formed on the raised regions 602 and 604 will not be electrically isolated. This is because sufficient electrically conductive material will be deposited on the sidewalls 608 and 610 and on the floor 606 to electrically connect the raised regions 602 and 604. In simple terms, at the angle of deposition depicted in FIGS. 6A and 7A, one can see an entire side of the sidewall 610 extending from the raised region 602 to the floor 606. One can also see an entire side of the sidewall 608 extending from the raised region 604 to the floor 606. Where electrically conductive material is deposited at the angle of deposition depicted in FIGS. 6A and 7A, it will coat all the surfaces that can be seen in FIGS. 6A and 7A. As such, an electrical path will be formed between the raised region 602 and the raised region 604, resulting in electrically connection between the regions 602 and 604.

By comparison, if electrically conductive material is deposited at an angle of deposition equal to the perspective view depicted in FIGS. 6B and 7B, the traces formed on the raised regions 602 and 604 will be electrically isolated. This is because insufficient electrically conductive material will be deposited on the sidewalls 608 and 610 and the on the floor 606, such that the raised regions 602 and 604 will not become electrically connected. In simple terms, at the angle of deposition depicted in FIGS. 6B and 7B, one cannot see an entire side of the sidewall 610 extending from the raised region 602 to the floor 606. That is, the portion of this side of the sidewall 610 where it meets the floor 606 is hidden from view. Therefore, although an entire side of the sidewall 608 extending from the raised region 604 to the floor 606 can be seen, where electrically conductive material is deposited at the angle of deposition depicted in FIGS. 6B and 7B, an electrical path will not be formed between the raised regions 602 and 604. Rather electrically conductive material will coat again just coat all the surfaces that can be seen in FIGS. 6B and 7B. Therefore, any electrical path from the raised region 602 to the raised region 604 is broken by the portion of the side of the sidewall 610 that cannot be seen in FIGS. 6B and 7B, where this side of the sidewall 610 meets the floor 606. As such, the raised regions 602 and 604 are electrically isolated.

In other words, the difference between the angles of deposition depicted in FIGS. 6A and 7A and FIGS. 6B and 7B is that in FIGS. 6A and 7A, an entire side of the sidewall 610 can be seen from the raised region 602 to the floor 606, such that the electrically conductive material coats this side of the sidewall 610. As such, there is an electrical connection between the traces formed on the raised regions 602 and 604. By comparison, in FIGS. 6B and 7B, an entire side of the sidewall 610 cannot be seen from the raised region 602 to the floor 606. As such, the electrically conductive material coating the exposed portion of this side of the sidewall 610 does not result in electrical connection between the traces formed on the raised regions 602 and 604. Therefore, the traces are electrically isolated.

The angle of deposition rises into or towards the z-axis from the plane of the substrate defined or denoted by the x- and y-axes. For a straight-line geometry, the angle of deposition may be determined as follows. First, several values are defined as follows.
h=trench depth
w=trench width
φ=angle of deposition
θ=angle of rotation
s=maximum shadow length
d=distance between sidewall bottoms along angle of rotation
   The value h is thus the depth of the trench, and as such can be considered as equal to the height of the sidewalls 608 and 610. The value w is the width of the trench, and as such can be considered as equal to the width of the floor 606 between the sidewalls 608 and 610. The value φ is the angle of deposition as has been described, whereas θ is the angle of rotation as has been described. The value s is the maximum shadow length across the floor 606 of the trench, in that, for instance, if the raised region 602 and the sidewall 610 were not present, the shadow cast by the raised region 604 at the angle of deposition would have the value s. Stated another way, if the raised region 602 and the sidewall 610 were not present, the electrically conductive material would not be deposited along the length s of a shadow on the resulting hypothetically infinite-in-length floor 606. Finally, the value d is the distance between the bottoms of the sidewalls 608 and 610 on the floor 606 along the angle of rotation. The value d is equal to or greater than the value w.

The values s and d can be determined as follows.

$$\begin{matrix}s = \frac{h}{TAN ϕ} & ( 1 ) \\ d = \frac{w}{SIN θ} & ( 2 )\end{matrix}$$

Now, to break the continuity of conductive material deposition between the raised regions 602 and 604, such that the resulting traces are electrically isolated from one another, the following relationship has to hold.

s≧d

That is, the maximum shadow length has to be equal to or greater than the distance between the bottoms of the sidewalls 608 and 610 on the floor 606 along the angle of rotation for any part of the substrate geometry. As such, the following relationship has to be satisfied in order to achieve electrical isolation of the traces:

$$\frac{h}{TAN ϕ} \geq \frac{w}{SIN θ}$$

Three of the four values h, w, φ, and θ may be specified, such that the remaining value may be determined based on this relationship. For instance, solving for the angle of deposition φ yields:

$$ϕ \leq A TAN ( \frac{h}{w} SIN θ ) \qquad ( 3 )$$

Thus, the maximum angle of deposition is specified by equation (3), wherein ATAN specifies the arctangent (i.e., the inverse-tangent) of the quantity in question.

Next, for a circular geometry, the angle of deposition may be determined as follows. First, several values are defined as follows:
h=trench depth
w=trench width
r=maximum radius of curvature of any curved trench
φ=angle of deposition
ω=angle to the shadowing point
s=maximum shadow length
d=distance between sidewall bottoms along angle of rotation
   As in the straight-line geometry, the value h is the depth of the trench, the value w is the width of the trench, s the value s is the maximum shadow length across the floor 606 of the trench in that, for instance, if the raised region 602 and the sidewall 610 were not present, the shadow cast by the raised region 604 at the angle of deposition would have the value s. Also as in the straight-line geometry, the value d is the distance between the bottoms of the sidewalls 608 and 610 on the floor 606 along the angle of rotation, and the value φ is the angle of deposition.

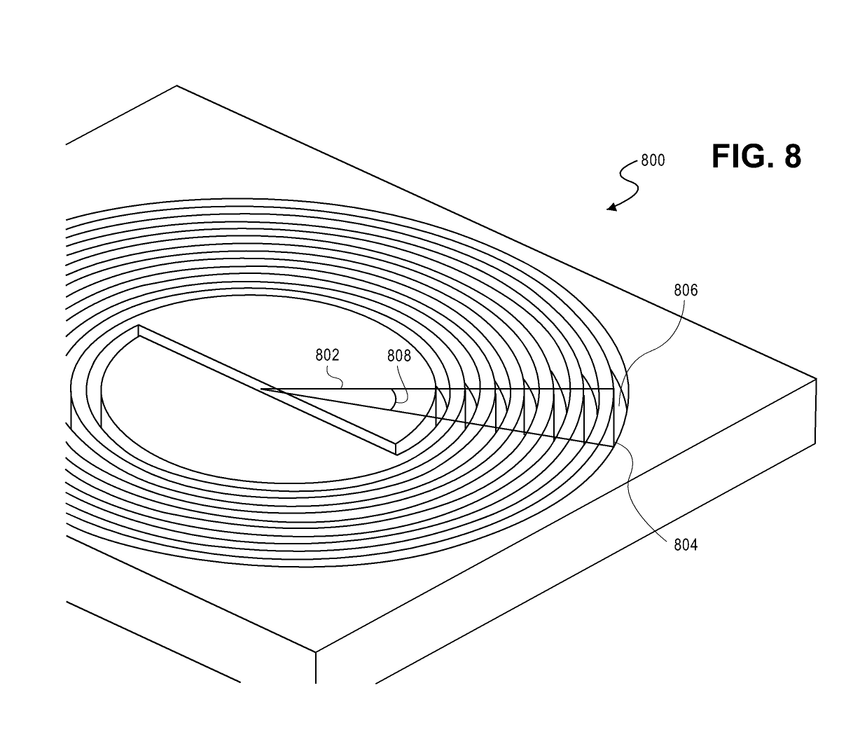

As to the values r and ω, FIG. 8 shows a representative electrical device 800 having a circular geometry in which these values r and ω are illustratively depicted, according to an embodiment of the present disclosure. The value r is represented by reference number 802 in FIG. 8, and is the maximum radius of curvature of any curved trench. The value ω is referenced by reference number 808 in FIG. 8, and is the angle to the shadowing point, as is described in the next paragraph. Trench 806 has the largest radius of all the trenches. The radius r of the trench 806 is thus defined as the distance from the center point of the circular geometry to the interior sidewall of the trench 806, as depicted in FIG. 8. Each trench has two sidewalls, an interior sidewall closer to the center point of the circular geometry, and an exterior sidewall farther from the center point.

Next, the sidewall distance d is represented by a tangent line 804 dropped at the end point of this radius r and intersects the exterior sidewall of the trench at a point that is referred to as the shadowing point. Drawing a line from the shadowing point to the center point of the circular geometry results in an angle defined between the radial line corresponding to the radius that has been discussed and this line from the shadowing point to the center point. This angle is the value ω, referenced by reference number 808 in FIG. 8.

The values s and d can then be determined as follows.

$$\begin{matrix}s = \frac{h}{TAN ϕ} & ( 4 ) \\ d = r TAN ( ω ) & ( 5 ) \\ COS ( ω ) = \frac{r}{r + w} & ( 6 ) \\ d = r TAN ( A COS \frac{r}{r + w} ) & ( 7 )\end{matrix}$$

In equations (5) and (7), ACOS defines the arccosine or inverse cosine function. Now to break the continuity of conductive material deposition between the raised regions 602 and 604, such that the resulting traces are electrically isolated from one another, the following relationship has to hold, as in the straight-line geometry case.

s≧d

That is, the maximum shadow length has to be equal to or greater than the distance between the bottoms of the sidewalls 608 and 610 on the floor 606.

As such, the following relationship holds:

$$\frac{h}{TAN ϕ} \geq r TAN ( A COS \frac{r}{r + w} )$$

Three of the four values h, w, r, and φ may be specified, such that the remaining value may be determined based on this relationship. For instance, solving for the angle of deposition yields:

$$ϕ \leq A TAN ( \frac{h}{r TAN ( A COS \frac{r}{r + w} )} ) \qquad ( 8 )$$

It is noted that relation in (8) assumes a “worst case” circular geometry, in which the curved trenches run parallel to the direction of deposition.

In practice, however, a geometry can be designed for a “best case” scenario, consistent with the desired function of the device in question. After the design layout has been completed, the substrate is examined to locate the worst case geometry, and the above calculations run to ensure that the conditions for electrical isolation of the traces is satisfied for this worst case geometry. If the conditions cannot be met, the layout would then be redesigned, and the process repeated, until electrical isolation can be achieved.

Two particular geometries have thus been discussed: a straight-line geometry, and a circular geometry. For both of these geometries, an angle of deposition has been shown how to be determined so that there is no continuity of conductive material deposition from one raised region to another. Thus, to achieve electrically isolated traces, in general, the various values denoted in the relationships in (3) and (8) are selected to maintain these relationships, so that there is no continuity of conductive material deposition from one raised region to an adjacent raised region. More generally still, for any particular geometric configuration having more than one geometry, the worst case geometry is located, and the angles of deposition and/or rotation are selected to avoid continuity of conductive material deposition from one raised region to another.

Referring back to FIG. 5, the method 500 concludes by depositing electrically conductive material at the angle of deposition relative to the substrate to form the electrically isolated conductive traces (508). The angle of deposition is relative to the substrate in that the angle of deposition rises from the plane of the substrate into or towards the z-axis from a given position on this plane. This position is specified on the plane via the angle of rotation. The deposition may be performed by vapor deposition, sputtering, or another type of deposition.

As has been noted, the angle of deposition is no more than a maximum value that ensures that the conductive traces formed on the raised regions of the pattern by the deposition of the electrically conductive material thereon remain electrically isolated from one another. That is, the angle of deposition is sufficiently small relative to the plane of the substrate that the electrically conductive material is insufficiently deposited along the sidewalls and floors of the trenches to result in electrical conductive between adjacent raised regions. As such, the trenches electrically isolate the conductive traces, and these traces are electrically isolated conductive traces. The electrically isolated conductive traces thus can be considered to have a physical configuration corresponding to deposition of the electrically conductive material on the substrate at the angle of deposition relative to the substrate.

We claim:

1. A method comprising:
imprinting a pattern into a substrate, the pattern having a plurality of raised regions and a plurality of trenches such that the raised regions are separated from one another by the trenches, the raised regions corresponding to electrically isolated conductive traces to be formed on the substrate;
determining at least an angle of deposition relative to the substrate at which an electrically conductive material is to be deposited on the substrate to form the electrically isolated conductive traces on the raised regions, the angle of deposition sufficient to ensure that adjacent raised regions remain electrically isolated; and,
depositing the electrically conductive material at no more than the angle of deposition relative to the substrate to form the electrically isolated conductive traces.

2. The method of claim 1, wherein the substrate is electrically insulative.

3. The method of claim 1, wherein imprinting the pattern into the substrate comprises imprinting the pattern over three dimensions of the substrate, including an x-axis and a y-axis of a plane of the substrate and a z-axis into the plane of the substrate.

4. The method of claim 1, wherein imprinting the pattern into the substrate comprises embossing or nano-imprinting the pattern into the substrate.

5. The method of claim 1, wherein the angle of deposition is sufficient to ensure that adjacent raised regions remain electrically isolated in that, during deposition of the electrically conductive material on the substrate at the angle of deposition, the electrically conductive material is insufficiently deposited along sidewalls and floors of the trenches to result in electrical conductivity between adjacent raised regions.

6. The method of claim 1, wherein the angle of deposition rises into a z-axis from a plane of the substrate denoted by an x-axis and a y-axis.

7. The method of claim 1, wherein determining the angle of deposition relative to the substrate at which the electrically conductive material is to be deposited on the substrate comprises, where the pattern has a straight-line geometry, determining the angle of deposition as a function of a width of the trenches, a depth of the trenches, and an angle of rotation.

8. The method of claim 1, wherein determining the angle of deposition relative to the substrate at which the electrically conductive material is to be deposited on the substrate comprises, where the pattern has a circular geometry, determining the angle of deposition as a function of a width of the trenches, a depth of the trenches, and a maximum radius of the trenches.

9. The method of claim 1, wherein determining the angle of deposition relative to the substrate at which the electrically conductive material is to be deposited on the substrate comprises, where the pattern has a plurality of geometries, locating a worst case geometry of the geometries and determining the angle of deposition for the worst case geometry.

10. The method of claim 1, further comprising determining an angle of rotation relative to a straight-line geometry of the pattern such that the angle of rotation is maximized relative to the straight-line geometry,
wherein the electrically conductive material is deposited at the angle of deposition above the substrate from a direction corresponding to the angle of rotation relative to the straight-line geometry of the pattern.

11. The method of claim 10, wherein the angle of deposition rises into a z-axis from a plane of the substrate denoted by the x-axis and the y-axis, the angle of rotation is relative to the straight-line geometry that is parallel to one of the x-axis and the y-axis, and the angle of rotation is within the plane of the substrate.

12. The method of claim 1, wherein depositing the electrically conductive material at the angle of deposition relative to the substrate comprises vapor-depositing or sputtering the electrically conductive material at the angle of deposition relative to the substrate.

13. An electrical device comprising:
an electrically insulative substrate having a pattern imprinted therein over three dimensions of the substrate, including an x-axis and a y-axis of a plane of the substrate and a z-axis into the plane of the substrate;
a plurality of raised regions and a plurality of trenches defined within the substrate and corresponding to the pattern imprinted into the substrate, the raised regions separated from one another by the trenches; and,
a plurality of electrically isolated conductive traces formed on at least the raised regions defined within the substrate,
wherein the electrically isolated conductive traces have a physical configuration corresponding to deposition of an electrically conductive material on the substrate at no more than a predetermined angle of deposition relative to the substrate rising into the z-axis from the plane of the substrate.

14. The electrical device of claim 13, wherein the pattern has a straight-line geometry, and the predetermined angle of deposition is determined as a function of a width of the trenches, a depth of the trenches, and an angle of rotation.

15. The electrical device of claim 13, wherein the pattern has a circular geometry, and the predetermined angle of deposition is determined as a function of a width of the trenches, a depth of the trenches, and a maximum radius of the trenches.

16. The electrical device of claim 13, wherein the pattern has a plurality of geometries, and the predetermined angle of deposition is determined for a worst case geometry of the geometries.

17. The electrical device of claim 13, wherein the electrical device is a radio-frequency identification (RFID) tag antenna.

18. A radio-frequency identification (RFID) tag antenna fabricated at least in part by a method comprising:
imprinting an antenna pattern into a substrate of the RFID tag antenna, the antenna pattern having a plurality of raised regions and a plurality of trenches such that the raised regions are separated from one another by the trenches, the raised regions corresponding to electrically isolated conductive traces to be formed on the substrate;
determining at least an angle of deposition relative to the substrate at which an electrically conductive material is to be deposited on the substrate to form the electrically isolated conductive traces on the raised regions, the angle of deposition sufficient to ensure that adjacent raised regions remain electrically isolated; and,
depositing the electrically conductive material at no more than the angle of deposition relative to the substrate to form the electrically isolated conductive traces of the RFID tag antenna,
wherein the electrically isolated conductive traces have a physical configuration corresponding to deposition of the electrically conductive material on the substrate at the angle of deposition relative to the substrate.

19. The RFID tag antenna of claim 18, wherein determining the angle of deposition relative to the substrate at which the electrically conductive material is to be deposited on the substrate comprises, where the pattern has a straight-line geometry, determining the angle of deposition as a function of a width of the trenches, a depth of the trenches, and an angle of rotation.

20. The RFID tag antenna of claim 18, wherein determining the angle of deposition relative to the substrate at which the electrically conductive material is to be deposited on the substrate comprises, where the pattern has a circular geometry, determining the angle of deposition as a function of a width of the trenches, a depth of the trenches, and a maximum radius of the trenches.
